(19) United States
(12) Patent Application Publication
(10) Pub. No.: US 2008/0149557 A1
(43) Pub. Date: Jun. 26, 2008

(54) Module with Filter Cartridges

(75) Inventor: Luc Reynders, Riemst (BE)

Correspondence Address: CROWELL & MORING LLP;INTELLECTUAL PROPERTY GROUP, P.O. BOX 14300, WASHINGTON, DC, 20044-4300, US

(73) Assignee: MANN & HUMMEL GmbH, Ludwigsburg (DE)

(21) Appl. No.: 11/956,906

(22) Filed: Dec. 14, 2007

Related U.S. Application Data
(63) Continuation of application No. PCT/EP2006/063144, filed on Jun. 13, 2006.

(30) Foreign Application Priority Data
Jun. 14, 2005 (DE) 10 2005 009 390.4

(51) Int. Cl. B01D 29/13

(52) U.S. Cl. 210/323.2

(57) ABSTRACT

A filter module for filtering liquids, particularly hot oils. The filter module is provided with a base plate (10) and filter tubes (11), such that the filter tubes (11) are individually connected to the base plate (10) in a detachable manner and a seal is formed between the filter tubes (11) and the base plate (10). Individual filter tubes can thus be exchanged with little effort.

### CROSS REFERENCE TO RELATED APPLICATIONS

This application is a continuation of international patent application no. PCT/EP2006/063144, filed Jun. 13, 2006, designating the United States of America, and published in German on Dec. 21, 2006, as WO 2006/134,105, the entire disclosure of which is incorporated herein by reference. Priority is claimed based on Federal Republic of Germany patent application no. DE 20 2005 009 390.4, filed Jun. 14, 2005.

### BACKGROUND OF THE INVENTION

The present invention relates to a filter module for filtering a liquid, comprising a base plate and a plurality of filter tubes sealingly connected to the base plate.

A prior-art filter module for filtering liquids is depicted in FIG. 1. The reference numerals below refer to FIG. 1. The filter module has a perforated base plate 110 into which filter tubes 111 are inserted. The filter tubes 111 have a widened collar 112, which rests against the base plate 110. To seal the filter tube 111 in relation to the base plate 110, an O-ring 113 is disposed in the region of the collar 112. Since the filter tube 111 is loosely inserted into the base plate 110, a clamping plate 114 is provided, which is screwed together with the base plate 110. This requires a plurality of closely spaced screws 115 because the clamping plate 114 must be uniformly pressed against the filter tubes 111 or their collars 112 to prevent leaking. The clamping plate 114 has bores 116 in the region of the filter tubes 111, through which the filtered liquid can flow off.

For mounting, the O-rings 113 must first be pushed over the filter tubes 111 before the filter tubes 111 are inserted into the base plate 110. Once the filter tubes 111 have all been inserted, the clamping plate 114 is put in place, aligned and fixed with a plurality of screws 115. Assembly of the filter module is thus time consuming. Maintenance or replacement of individual filter tubes 111 also requires a substantial amount of effort. All screws 115 must be removed from the clamping plate 114 and the clamping plate 114 must be lifted off for this purpose. The filter module is furthermore unsuitable for use at high temperatures. High temperatures can damage the O-rings 113, so that they are unable to perform their function.

### SUMMARY OF THE INVENTION

It is, therefore, an object of the invention to provide an improved filter module with filter cartridges.

Another object of the invention is to provide a filter module with filter cartridges in which the filter cartridges can be easily exchanged individually with a minimal amount of effort.

A further object of the invention is to provide a filter module with filter cartridges which is well adapted for filtering high temperature liquids.

These and other objects are achieved in accordance with the present invention by providing a filter module for filtering a liquid, the module comprising a base plate and a plurality of filter tubes sealingly connected to the base plate by a releasable connection; the filter tubes and the base plate being provided with mating threads, and each filter tube being screwed together with the base plate, the threads thereby forming the releasable connection between the filter tubes and the base plate and simultaneously forming the seal between the filter tubes and the base plate, wherein the threads have a diameter larger than the diameter of the filter tubes.

The filter module according to the invention is used to filter liquids and comprises a base plate and filter tubes. The base plate is formed of a material impermeable to the liquid being filtered, particularly of high-grade steel. The filter tubes have a region that is permeable to the liquid being filtered at least in partial areas. This region permeable to the liquid being filtered may be formed of the material itself or by corresponding perforations. The filter tubes are preferably made of high-grade steel or a material that is not corrodible by the liquid. The filter tubes are formed, for example, of wedge-wire screen tubes or slotted tubes covered with a V2A fabric. The filter tubes are releasably and sealingly connected to the base plate. This releasable connection simultaneously forms the seal between the filter tubes and the base plate, eliminating the need for thermally sensitive sealing elements. Thus, the filter module according to the invention can also be used at elevated operating temperatures. The releasable connection of the individual filter tubes to the base plate makes it easily possible to remove and replace any defective filter tubes, since only a single connection must be released. The remaining filter tubes are not affected by the replacement of the defective filter tube.

According to another embodiment of the invention, the filter tubes and the base plate have mutually corresponding threads forming the releasable connection between the filter tubes and the base plate. Each filter tube is therefore screwed together with the base plate. The threads may be formed directly on the filter tube and the base plate. As an alternative, it is also possible, however, to connect separate thread elements to the base plate or the filter tube in a sealing manner. This is required particularly in the case of sensitive or brittle materials, such as ceramics, where the direct forming of threads is problematic. In these embodiments, the thread element is made of a different material than the base plate or the filter tube. The thread element is then, for example, welded, pressed or bonded to the filter tube. This makes it possible to fasten filter tubes formed of a sensitive or difficult-to-machine material to the base plate.

In yet another embodiment of the invention, a threaded sleeve is connected, particularly welded, to the filter tubes so as to form a seal. The threaded sleeve, which is provided with an external thread, is sealingly screwed into an internal thread formed in the base plate. The threads may have any of the geometries known in the art. In particular, self-locking threads may be used, e.g., buttress threads, to prevent accidental loosening of the filter tubes from the base plate.

In one advantageous embodiment, the internal thread is cylindrical. A filter tube with preferably a conical external thread is screwed into this cylindrical internal thread. The combination of a cylindrical internal thread and a conical external thread provides a sealing connection between the two components being joined. The external thread of the filter tube or the threaded sleeve is screwed into the internal thread of the base plate as far as it will go. Once the filter tube cannot be screwed in any further, the connection in the threaded region between the filter tube and the base plate is liquid-tight. Because of the liquid-tight connection between the filter tube and the base plate, this filter module design is excellently suited for use in very hot or aggressive media where conventional seals would be destroyed. This filter module is particularly suitable for filtering hot oil, since high thermal stability and chemical resistance are required in this application.

### BRIEF DESCRIPTION OF THE DRAWINGS

The invention will be described in further detail hereinafter with reference to illustrative preferred embodiments shown in the accompanying drawing figures, in which:

FIG. 1 shows a detail of a filter module according to the prior art;

FIG. 2 shows a filter module in a perspective view;

FIG. 3 shows filter tubes in a perspective view;

FIG. 4 is a sectional view of the base plate shown in FIG. 2, and

FIG. 5 shows a detail of the filter module shown in FIG. 4.

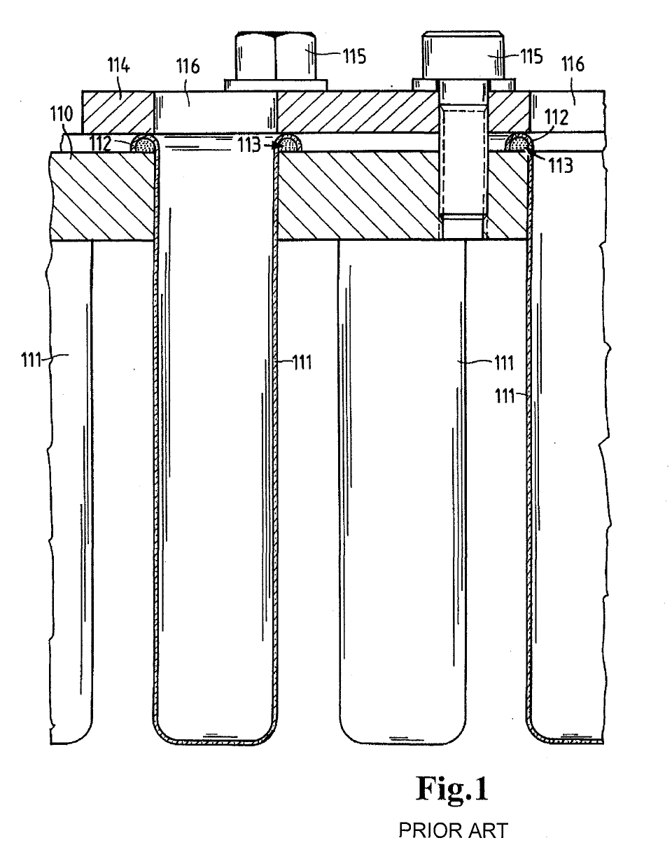

### DETAILED DESCRIPTION OF PREFERRED EMBODIMENTS

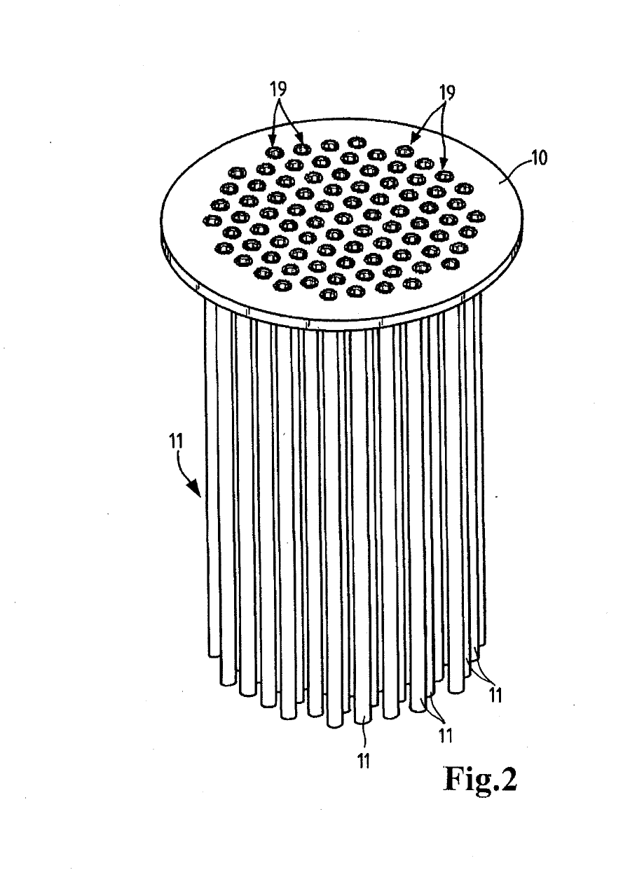

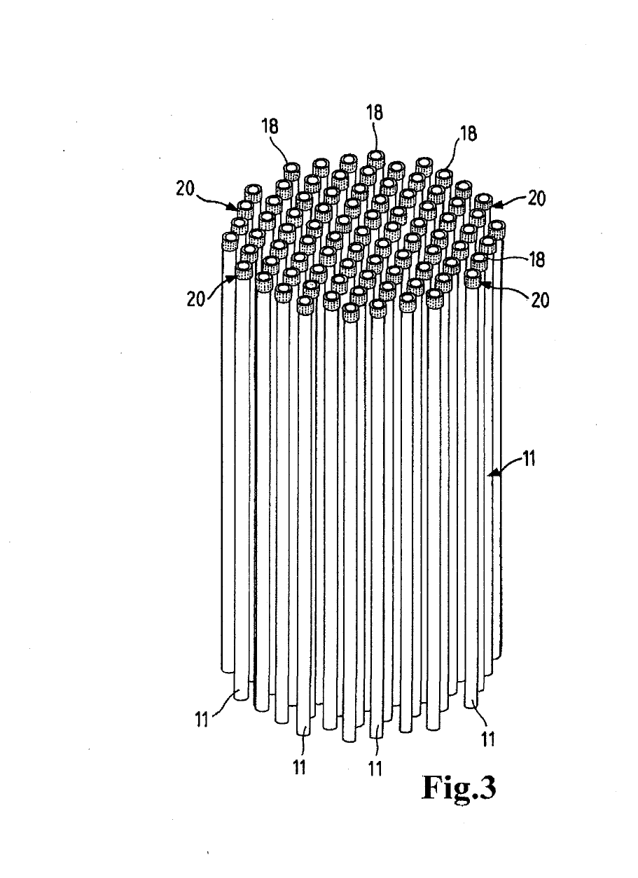

FIG. 2 is a perspective view of a filter module. The filter module has a base plate 10 and a plurality of filter tubes 11. For filtering a liquid, particularly for filtering oils, the filter module is insertable into a filter housing (not shown). The base plate 10 has internal threads 19, such that the number of internal threads 19 corresponds to the number of the filter tubes 11 being used. If the number of internal threads 19 exceeds that of the filter tubes 11, plugs (not depicted) must be provided to seal the unused internal threads 19. The filter tubes 11 are rod-shaped and closed at their lower end face. The liquid being filtered must flow through the walls of the filter tubes 11 to reach the filtered side from the unfiltered side, which surrounds the filter tubes 11. The filtered side communicates with the interior of the filter tubes 11. The topside of the base plate 10 also communicates with the filtered side, whereas the bottom side of the base plate 10 is in contact with the unfiltered side. The filter tubes 11 have threaded sleeves 18 arranged on the end opposite the closed end as shown in FIG. 3. The threaded sleeves 18 have external threads 20, which are screwed into the internal threads 19 of the base plate 10.

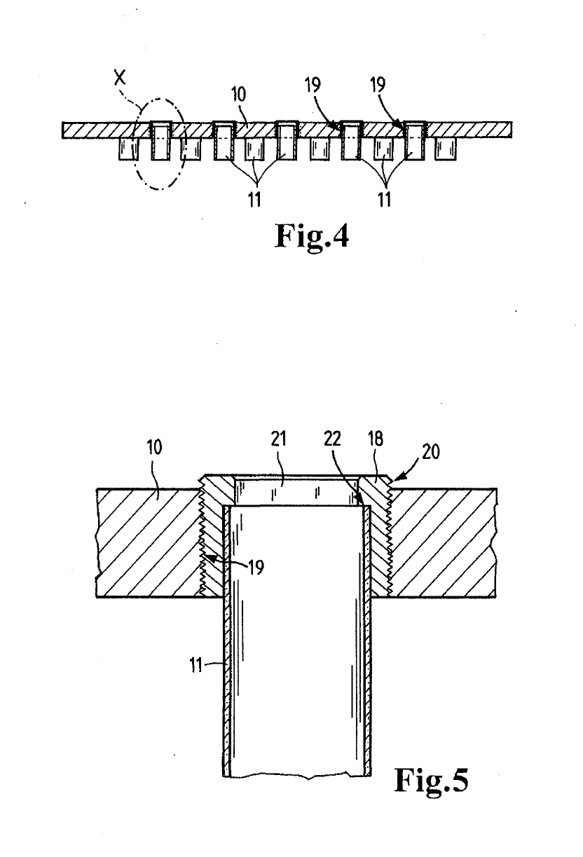

FIG. 4 is a sectional view of the filter module depicted in FIG. 2. Components corresponding to those of FIG. 2 are provided with the same reference numerals. The filter tubes 11 are individually screwed into the base plate 10, so that a tight connection is produced between the base plate 10 and the filter tubes 11.

FIG. 5 shows a detail X of FIG. 4. Components corresponding to those of FIG. 4 are identified by the same reference numerals. This detail shows the connection between the base plate 10 and the filter tube 11, with the filter tube 11 screwed into the base plate 10 with its threaded sleeve 18. The threaded sleeve 18 is shrunk-fit onto the filter tube 11 so as to produce a permanent bond between the threaded sleeve 18 and the filter tube 11. Alternatively, the filter tube 11 can also be bonded, soldered or welded into the threaded sleeve 18. As can be seen from the drawing, the external thread 20 has a diameter larger than the diameter of the filter tube 11. The external thread 20 of the threaded sleeve 18 is conical, such that the diameter of the external thread 20 tapers in screw-in direction. The diameter of the external thread 20 protruding over the filter tube 11 is, therefore, smaller than the diameter pushed onto the filter tube 11. The threaded sleeve 18 furthermore has a passage opening 21, through which the filtered liquid can flow out of the interior of the filter tube 11. To prevent slippage of the filter tube 11 through the threaded sleeve 18 during assembly or filtration, a shoulder 22 is provided, against which the upper end face of the filter tube 11 rests. The internal thread 19 of the base plate 10 is cylindrical. Screwing in the conical threaded sleeve 18 forms a seal between these two components. At the same time, the threaded sleeve cannot be screwed through the base plate 10. Screwing in the threaded sleeve 18 with a predefined torque furthermore reduces the mechanical loading of the filter tube 11 during assembly because the conical threaded sleeve 18 can initially be screwed in with very little force. On the other hand, the threaded sleeve 18 is clamped as it is screwed in, such that any accidental loosening is prevented.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A filter module for filtering a liquid, said module comprising a base plate and a plurality of filter tubes sealingly connected to the base plate by a releasable connection; the filter tubes and said base plate being provided with mating threads, and each filter tube being screwed together with the base plate, said threads thereby forming the releasable connection between the filter tubes and the base plate and simultaneously forming the seal between the filter tubes and the base plate, wherein said threads have a diameter larger than the diameter of the filter tubes.

2. A filter module as claimed in claim 1, wherein each filter tube is sealingly connected to a respective threaded sleeve, and the threaded sleeves are each sealingly screwed into a respective internally threaded aperture in the base plate.

3. A filter module as claimed in claim 2, wherein each filter tube is sealingly welded to the respective threaded sleeve.

4. A filter module as claimed in claim 2, wherein the respective apertures have cylindrical internal threads.

5. A filter module as claimed in claim 2, wherein the threaded sleeve has a conical thread.
